(19) United States
(12) Patent Application Publication
(10) Pub. No.: US 2013/0157128 A1
(43) Pub. Date: Jun. 20, 2013

(54) ELECTRODE FOR LITHIUM BATTERIES AND ITS METHOD OF MANUFACTURE

(71) Applicant: Commissariat A L'Energie Atomique Et Aux Energies Alternatives, Paris (FR)

(72) Inventors: Sébastien SOLAN, Seyssinet-Pariset (FR); Nelly GIROUD, Saint Etienne (FR)

(73) Assignee: Commissariat A L'Energie Atomique Et Aux Energies Alternatives, Paris (FR)

(21) Appl. No.: 13/766,085

(22) Filed: Feb. 13, 2013

Related U.S. Application Data
(63) Continuation of application No. PCT/FR2011/051996, filed on Aug. 31, 2011.

(30) Foreign Application Priority Data
Sep. 22, 2010 (FR) 10.57592

(51) Int. Cl. H01M 4/80

(52) U.S. Cl. CPC H01M 4/80
USPC 429/211; 427/113

(57) ABSTRACT

The electrode for a lithium battery comprises a porous current collector made of woven or nonwoven carbon fibers.

### FIELD OF THE INVENTION

The present invention relates to an electrode for a lithium battery comprising a current collector made of carbon fibers.

The field of use of the present invention specifically relates to lithium electrochemical generators operating based on the principle of insertion and/or desinsertion (or intercalation/deintercalation) of lithium on at least one electrode.

### BACKGROUND

Among lithium-ion batteries, Li ion, non-rechargeable primary batteries can be distinguished from secondary batteries capable of being recharged. Generally, a lithium battery comprises two electrodes separated by an electrolytic component. These electrodes, one being positive and the other negative, are each connected to a current collector made of a material that may change according to the nature of the electrode.

Generally, the positive electrode is made of materials for inserting the lithium cation, while the negative electrode is often made of carbon graphite, of silicon, of silicon carbide, or of metal lithium.

The electrolytic component comprises a polymer or microporous composite separator impregnated with organic electrolyte, enabling to displace the lithium ion from the positive electrode to the negative electrode and conversely (in the case of the charge or the discharge), thus generating the current. On the other hand, the electrolyte is a mixture of organic solvents into which is generally added a lithium salt.

It is well established that a lithium battery electrode can be formed from an ink comprising an active powder material, an electronic conductor, and a polymer binder. The ink formulation mainly depends on the active electrode material and thus on the envisaged type of Li ion battery.

Indeed, since active materials each have a specific capacity (see table 1 hereafter), the electrode is selected according to the accumulator. For example, the electrode is thin with a light basic weight for so-called power accumulators, withstanding high discharge rates. However, the electrode is thicker and with a greater basic weight for so-called energy accumulators adapted to slower charge rates (C/5 or even C/2).

TABLE 1
SPECIFIC CAPACITIES OF THE MAIN
ELECTRODE MATERIALS

| | Specific capacity |
|---|---|
| Active material | (mAh · g⁻¹) |
| Cgr | 310 |
| Li₄Ti₅O₁₂ | 160 |
| Silicon | >4000 |
| SiC | >500 |
| LiCoO₂ | 160 |
| LiNi_{0.33}Mn_{0.33}Co_{0.33}O₂ | 130 |
| Li(Ni,Co, Al)₁O₂ | 160 |
| LiFePO₄ | 140 |
| LiNi_{0.4-0.5}Mn_{1.5-1.6}O₄ | 160 |

The current collectors having the electrodes deposited thereon are generally metallic and may be made of:
aluminum for positive electrodes;
aluminum for a negative Li₄Ti₅O₁₂ titanate electrode;
copper for negative electrodes made of graphite (Cgr), silicon (Si), or silicon carbide (Si—C);
stainless steel;
nickel;
nickel-plated copper.

However, such metal current collectors may have several disadvantages. Indeed, their relatively high density causes a decrease in the energy density of lithium batteries. Further, they alter along cyclings (corrosion), thus decreasing the lifetime of the lithium accumulator. Finally, the electrodes poorly bond to the metallic current collector. A separation is often observed when the electrode and/or the battery are mechanically stressed, especially in the case of aqueous electrodes.

To overcome some of these problems, current collectors containing carbon have been developed. For example, document JP59035363 describes a positive electrode current collector prepared by mixing carbon fibers and CMC (carboxymethylcellulose). The obtained paste is then molded in a curved printing plate, dried and burnt under a nitrogen atmosphere.

Document JP 11339774 describes a carbon fiber paper current collector. A secondary lithium battery electrode is prepared by deposition of a composite layer paste made of a metal oxide and of a binder (polyaniline/ disulfonic acid)

Document WO2007/118281 discloses a flexible current collector comprising a non-conductive material and a conductive material, which may be carbon fibers.

The deposition of an electrode on a current collector of prior art has certain constraints due to the nature of the binder or to the deposition technique (paste). Further, mixing a conductive material with a polymer or a non-conductive material burdens the current collector and decreases the energy density of the battery.

The Applicant has developed an electrode comprising a support enabling to avoid prior art shortcomings, and having a collector with the following advantages:
increased flexibility with respect to conventional metal collectors;
bonding of the electrode to the support;
current collector lifetime;
increase of the energy density of the battery;
deposition of the electrode ink by coating or printing.

### DISCUSSION OF THE INVENTION

The present invention relates to an electrode for a lithium battery comprising a current collector made of carbon fibers, as well as to its manufacturing method. This electrode has a porous current collector, made of carbon fibers.

Typically, the current collector, or electrode current collector, is made of woven or nonwoven carbon fibers, more advantageously of nonwoven carbon fibers. Advantageously, the current collector of the electrode according to the invention has a porosity ranging between 70% and 85%, typically on the order of 80%.

The use of carbon fibers has several advantages over prior art current collectors. Indeed, a nonwoven carbon current collector formed of interlaced carbon fibers has the following main characteristics:
decomposition temperature=600° C., enabling to use it in high-temperature batteries;
good electronic conductor;
porous material having a high surface roughness, thus allowing a very good bonding of electrode inks;
good printing definition;
adapted to conventional coating methods;
flexible and resilient material;
light and inexpensive material. The density of the nonwoven carbon felt is much smaller than that of the most currently-used metal collectors (table 2).

TABLE 2
DENSITY OF THE MOST CURRENT METAL
COLLECTORS AND OF CARBON NONWOVEN

| | Density |
|---|---|
| Collector material | (g · cm⁻³) |
| Aluminum | 2.69 |
| Copper | 8.87 |
| Nickel-plated copper. | 8.95 |
| Nickel | 8.90 |
| Stainless steel | 8.02 |
| Carbon nonwoven felt | 0.628 |
| (ref H2315V1)⁽ⁱ⁾ | |

⁽ⁱ⁾Freudenberg H2315, PEMFC GDL.

The present invention also relates to the forming of an electrode for a lithium battery, by deposition of an electrode ink on said current collector. Said electrode may be positive or negative. Preferably, it is a negative electrode.

Advantageously, the electrode ink deposition is performed by coating or by printing (screen printing, flexography, rotogravure, inkjet).

The current collector being porous, it is further possible to have the active materials of the ink penetrate into its structure by performing the coating under suction, for example.

The present invention thus relates to the method for forming an electrode for a lithium battery, comprising the steps of:
depositing an electrode ink on a current collector made of carbon fibers by coating or printing; said ink comprises at least one active electrode material, at least one polymer binder, at least one electronic conductor. Typically, the collector thickness may range between 100 and 400 micrometers, and may for example be on the order of 160 micrometers.
drying: evaporating the solvent. Typically, the electrode may be dried in an oven with air circulation at 60° C.

The current collector is porous and made of woven or nonwoven carbon fibers. Further, the polymer ink binder advantageously is PAAc (poly(acrylic acid)), especially when the current collector is made of nonwoven carbon fibers.

Optionally, the above forming method may comprise a step of ink suction from the collector simultaneously to the deposition step or to the drying step or between these two steps, by any means within the abilities of those skilled in the art, such as for example on a drying table.

Further, the electrode may be calendered or compressed, even though, in the context of the invention, this step is unnecessary when PAAc (poly(acrylic acid)) is used as an electrode binder.

Further, given the fragility of the nonwoven collector, a calendering step according to prior art is not recommended; according to the invention, it has been shown that the use of a PAAc type polymer as an electrode binder enables to do away with this calendering step, while keeping the properties of electrodes.

Generally, the ink comprises at least one active material, at least one polymer binder, as well as at least one electronic conductor. The polymer binder, PVDF (poly vinylidene fluoride) in an organic mode (organic solvent) or a water-soluble polymer such as PAAc in aqueous mode (aqueous solvent), has the function of ensuring the mechanical strength of electrodes while providing a good contact between the electrolyte and the grains of material. The electronic conductor, generally carbon black, improves the electronic conductivity of electrodes.

Thus, as already mentioned, in the context of the invention, the polymer ink binder preferably is PAAc (poly(acrylic acid)), especially when the current collector is made of nonwoven carbon fibers. Preferably, it is a PAAc with a molecular weight ranging between 1.000.000 and 2.500.000 g.mol⁻¹, more specifically on the order of 1.250.000 g.mol⁻¹.

The composition of the obtained ink varies according to the material used and to the targeted application. Thus, the basic weight of the electrode and thus the mass of active material per surface area unit may be adjusted by controlling the proportion of active material and the coating thickness of the formulated inks on the current collector. Generally, the basic weight is directly translated in area capacity with respect to the specific capacity (in mAh.cm⁻²) of the considered active material.

The lithium battery electrode capable of being obtained according to the above-described embodiment also falls within the framework of the present invention. Said electrode may be positive or negative.

The invention thus also relates to an electrode for a Li-ion battery comprising at least a PAAc-type polymer binder, a material for inserting Li, and possibly an electronic additive of carbon fiber or black type deposited on a current collector of nonwoven carbon fiber type.

Advantageously, the area capacity of the electrode according to the present invention ranges between 0.1 and 10 mAh.cm⁻², and more advantageously between 0.3 and 5 mAh.cm⁻².

It should be noted that the material forming the current collector of the electrode—object of the invention, has lithium insertion properties when it is used as a negative electrode with or without negative ink deposition. Indeed, the use of such negative electrode current collectors enables to obtain more capacity, the collector material inserting lithium within its structure. The Applicant has thus found that, surprisingly, this current collector can also be used as a negative electrode material by itself since it reversibly inserts lithium ions. Thus, the present invention also embraces the negative electrode for a lithium battery comprising the above-described porous current collector made of carbon fibers as an electrochemically-active material.

Accordingly, the surface capacity of the negative electrode (deposited on the carbon fiber current collector) may be greater than that of the active electrode material. Indeed, the collector capacity adds to that of the deposited active material.

In the context of the present invention, the positive or negative electrodes capable of being formed by deposition of an ink on the current collector made of carbon fibers comprise the following electrodes, without this being a limitation:
negative electrodes made of graphite Cgr;
negative electrodes made of silicon Si;
negative electrodes containing silicon carbide;
positive electrodes made of LiNi_{0.33}Mn_{0.33}Co_{0.33}O₂;
positive electrodes made of LiNi_{0.5}Mn_{1.5}O₄;
positive electrodes made of LiFePO₄.

According to a very specific embodiment, at least one positive electrode and/or at least one negative electrode may be deposited on the same porous current collector made of woven or nonwoven carbon fibers.

The present invention also relates to a lithium accumulator comprising at least one electrode having a porous carbon fiber current collector, such as described hereabove. The present invention also relates to a secondary lithium battery comprising at least one of these lithium accumulators.

Without this being a limitation, secondary lithium batteries and lithium-ion accumulators according to the invention may comprise at least one couple of electrodes selected from the group especially comprising the following negative electrode/positive electrode pairs:
carbon graphite/LiFePO₄;
carbon graphite/LiNi_{0.33}Mn_{0.33}Co_{0.33}O₂;
carbon graphite/LiNiₓCo_{y}Al_{z}O₂ with x+y+z=1;
carbon graphite/LiMnO₂;
carbon graphite/LiNiO₂;
titanate Li₄Ti₅O₁₂/LiFePO₄;
titanate Li₄Ti₅O₁₂/LiNi_{0.4-0.5}Mn_{1.5-1.6}O₄;
carbon graphite/LiNi_{0.4-0.5}Mn_{1.5-1.6}O₄.

The present invention also relates to a primary lithium battery comprising at least one electrode according to the present invention. A primary lithium battery is not rechargeable.

Among the countless combinations, it will be within the abilities of those skilled in the art to select the appropriate active material and electrode according to the targeted application.

### BRIEF DESCRIPTION OF THE DRAWINGS

The invention and the resulting advantages will better appear from the following drawings and examples.

FIG. 1 illustrates the components of a prior art lithium battery.

FIG. 2 shows a diagram describing the components of a prior art button cell, as well as their order.

FIG. 3 shows a scanning electron microscope image of the carbon nonwoven used as a current collector.

FIG. 4a shows a photograph of a positive LiFePO₄ electrode (16) and of a negative Cgr electrode (17) coating the same current carbon nonwoven collector (15).

FIG. 4b shows a photograph illustrating the definition quality of a positive LiFePO₄ electrode formed by printing (screen printing) on a carbon nonwoven current collector.

FIG. 4c shows a photograph illustrating the flexibility of a positive LiFePO₄ electrode (16) and of a negative Cgr electrode (17) coating a current carbon nonwoven collector (15).

FIG. 4d shows a photograph illustrating the bonding of a positive LiFePO₄ electrode (16) and of a negative Cgr electrode (17) coating a current carbon nonwoven collector (15).

FIG. 5 illustrates the specific capacity in mAh.g⁻¹ of a positive LiFePO₄ electrode at different charge and discharge rates.

FIG. 6 illustrates the specific capacity in mAh.g⁻¹ of a negative Cgr electrode at different charge and discharge rates.

FIG. 7 illustrates the specific capacity in mAh.g⁻¹ recovered for the sole carbon nonwoven collector.

### DETAILED DESCRIPTION OF THE DRAWINGS

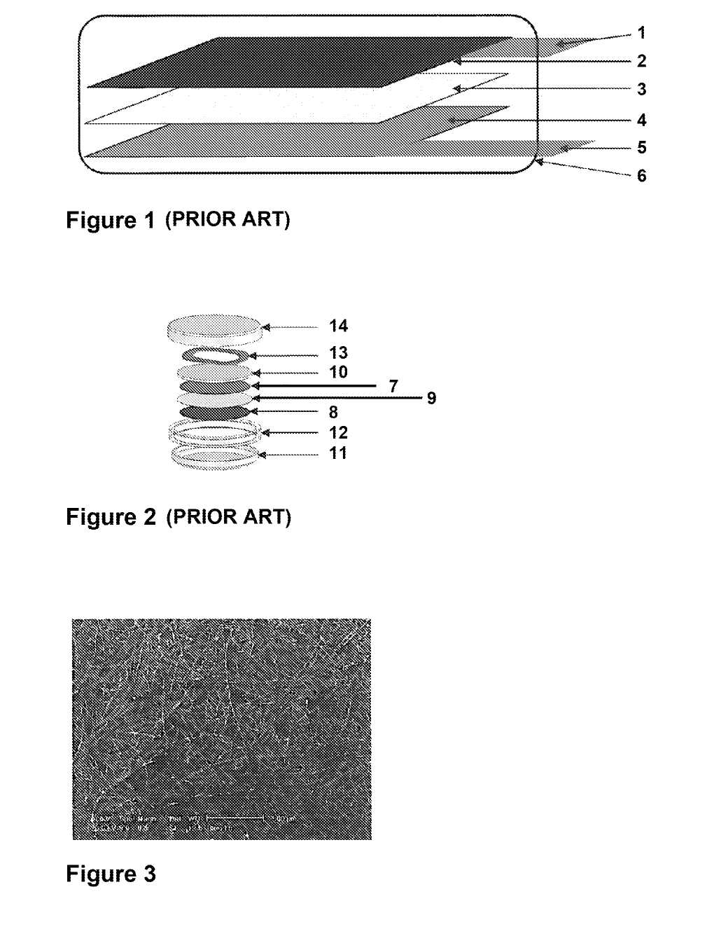

FIG. 1 illustrates the components of a lithium ion battery. A first current collector (1) is fixedly attached to a positive electrode (2), formed of material for inserting the lithium cation. Such insertion materials generally are composite materials such as for example LiFePO₄ (lithium iron phosphate), or oxides of transition metals (laminar materials: LiCoO₂: lithium cobalt oxide, LiNi_{0.33}Mn_{0.33}Co_{0.33}O₂ . . . ).

The positive electrode (2) and the negative electrode (4) are separated by an electrolytic component (3). This element is itself formed of a polymer or macroporous composite separator impregnated with organic electrolyte enabling to displace the lithium ion from the positive electrode to the negative electrode and conversely (in the case of the charge or the discharge), thus generating the current. The electrolyte is a mixture of organic solvents, generally associated with a lithium salt LiPF₆. This mixture must be free, as much as possible, of traces of water or of oxygen.

The negative electrode (4) is typically made of carbon graphite, of metal lithium or, in the case of power electrodes, of Li₄Ti₅O₁₂ (titanate material).

A second current collector (5) is fixedly attached to the negative electrode (4).

Elements (2), (3), and (4) altogether form what is commonly called electrochemical core (by extension, collectors (1) and (5) are also part of this core since they are attached to the electrodes). The electrochemical core is wrapped in a package (6).

FIG. 2 shows a diagram describing the components of a button cell, as well as their order. The negative electrode (8) is separated from the positive electrode (7) by a separator (9).

After a gasket (12) has been deposited at the bottom of the cell (11), the negative electrode (8), the separator (9), and the positive electrode (7) are deposited at the bottom of the cell. The positive electrode (8) is covered with a stainless steel wedge (10) on which a spring is then deposited (13) before the assembly is covered with a cap (14).

The current collectors are an integral part of electrodes (7) and (8).

### EMBODIMENTS OF THE INVENTION

A positive electrode (LiFePO₄) and a negative electrode (Cgr) have been prepared by means of two inks, having their formulations detailed in table 3 hereafter.

The electrodes are formed by an aqueous method, the polymer binder used being water-soluble. The ink dry extract is adjusted by addition of water. It is however also possible to form these inks by an organic method, that is, by using polyvinylidene fluoride (PVDF) as a binder and N-methyl-2-pyrrolidone (NMP) as a solvent.

TABLE 3
INK FORMULATION, AND RESULTS OBTAINED
FOR THE LiFePO₄ AND Cgr COATINGS WITH BINDING
POLYMER PAAc.

| | | LiFePO₄ | | Cgr | |
|---|---|---|---|---|---|
| | | | Inser- | | Inser- |
| | | | tion | | tion |
| | | Case (a) | order | Case (b) | order |
| Formulation | Active | LiFePO₄⁽ⁱ⁾ | 1 | Cgr⁽ⁱⁱ⁾ | 1 |
| (% weight | material | (94%) | | (68%) | |
| with respect to | Electronic | Super P⁽ⁱⁱⁱ⁾ | 2 | SFG6^{(iv)} | 1 |
| the ink weight) | Conductor | (1%) | | (17 %) | |
| | Carbon | Vgcf^{(iv)} | 3 | Tenax^{(iv)} | 1 |
| | fibers | (1%) | | (5%) | |
| | Binding | PAAc^{(v)} | 4 | PAAc^{(v)} | 2 |
| | polymer | (4%) | | (10%) | |
| | Water | Adjustable | 5 | Adjustable | 3 |
| | | for the | | for the | |
| | | dry extract | | dry extract | |

| | | |
|---|---|---|
| Dry extract | 33.6% | 19.6% |
| Wet coating thickness | 300 μm | 300 μm |
| Basic weight | 1.7 | 4.7 |
| (mAh · cm⁻²) | | |
| Volume capacity | 70 | 220 |
| (mAh · cm⁻³) | | |
| General porosity | 76% | 65% |

⁽ⁱ⁾LiFePO4 is provided by Pulead Technology Industry
⁽ⁱⁱ⁾MCMB 2528
⁽ⁱⁱⁱ⁾Super P = carbon black
^{(iv)}SFG6, Vgcf, Tenax = carbon fibers
^{(v)}PAAc = polyacrylic acid polymer; molecular weight = 1 250 000 g · mol⁻¹, solution at 3.5% by weight in water.

The coating of the current collector is performed under suction to have the electrode material penetrate within the carbon nonwoven structure. Once the ink has been spread and dried on the carbon nonwoven collector, pellets having a 14-mm diameter are cut by means of a cutting die. They are then weighted and their thickness is measured. The capacity in milliamperes hour (mAh) of the pellet is then calculated from the mass of active material contained in the pellet (equations 1 to 3):

m_{MA}=(mₜₒₜ−m_{collector})*%(MA)/100 (1)

for the negative electrode: m_{MA}=(mₜₒₜ−m_{collector})*%(MA)/100+m_{collector} (2)

Cₚₑₗₗₑₜ=m_{MA}*C_{MA}*1000 (3)

m_{MA}=mass of active material

mₜₒₜ=total mass of the pellet

m_{collctor}=mass of the pellet of current collector alone of same diameter

%(MA)=percentage of active material in the formulation

C_{MA}=specific capacity of the active material (mAh.g⁻¹)

The value of the dry extract, corresponding to the percentage of solid matter with respect to all the ink components, is calculated from equations 4 and 5:

mₜₒₜ(Powders)=(m_{MA}+m_{CE}+m_{fibers}+m_{solid binder}) (4)

es={(m_{powders})/(m_{powders}+m_{added water}+m_{binder water})}*100 (5)

m_{CE}=electronic conductor mass

fibers=mass of added fibers

m_{solid binder} mass of solid polymer

m_{added water}=mass of water (mass of organic solvent, if present) added to the powder mixture to give it an adequate consistency

m_{binder water}=mass of water incorporated at the same time as the solid binder, which has been previously solubilized

Masses are expressed in milligrams (mg).

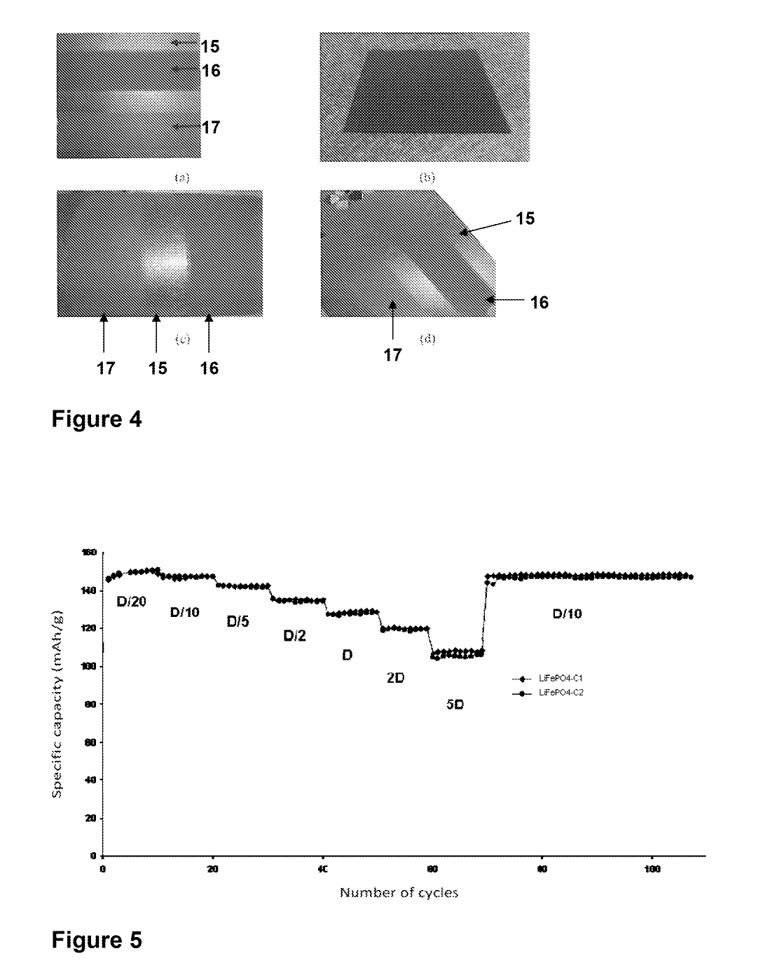

The obtained electrodes are homogeneous, with no spatters (clusters of material), with no cracks, and flexible (FIG. 4). The cutting of the pellet with the cutting die induces no separation of the electrode from the pellet periphery. The electrode bonding on the carbon nonwoven is thus very good.

The basic weights and porosities obtained for electrodes formed by coating with 94% and 90% of active material for the different dry extracts are summed up in table 3. Thick electrodes, thus having a high basic weight (surface and volume) have a very good bonding of the ink on the current collector. Further, these electrodes are flexible and do not separate from the current collector.

(In the case of the negative Cgr electrode, the percentage of active materials comprises the quantity of electronic conductor and of carbon fibers.)

### Charge-Discharge Cycling Tests

These inks have been tested in half-cell cycling according to the following configurations:
metal Li//PE EC/PC/DMC mixture (1/1/3) (1 M LiPF₆)+2% w VC//LiFePO₄;
metal Li//PE EC/PC/DMC mixture (1/1/3) (1 M LiPF₆)+2% w VC//Car.

EC=Ethylene carbonate;

PC=propylene carbonate;

DMC=dimethylcarbonate;

1/1/3=proportion by volume;

1M LiPF₆=1 mol/liter of LiPF₆ salt;

2% w VC=2% by weight of vinylene carbonate;

PE=polyethylene (Celgard 2400).

The test protocol for the positive electrode (LiFePO₄) is comprised of the steps of:

1) 10 C/20-D/20 charge and discharge cycles (forming step);

2) 10 C/10-D/10 charge and discharge cycles;

3) 10 C/5-D/5 charge and discharge cycles;

4) 10 C/3-D/3 charge and discharge cycles;

5) 10 C-D charge and discharge cycles;

The test protocol for the negative electrode (Cgr) is comprised of the steps of:

1) 5 C/20-D/20 charge and discharge cycles followed by a floating step to properly complete the charge and the discharge (forming step) (floating corresponds to a completed charge or discharge step to reach the potential);

2) 50 C/10-D/10 charge and discharge cycles still completed with a floating step.

A C/20 charge cycle means that a constant current is imposed to the battery for 20 hours, the value of the current being equal to the capacity divided by 20. A D/5 cycle corresponds to a discharge of 5 hours.

### Positive Electrode Cycling Test Results:

The positive LiFePO₄ electrode coating the nonwoven carbon support has a very good performance (table 4 and FIG. 5). Indeed, the recovered specific capacities are greater than the theoretical specific capacity of the material (140 inAh.g⁻¹, see table 1). The material then restores its full capacity. Further, these results are very stable, there is no loss of capacity during cycles.

TABLE 4
AVERAGE SPECIFIC CAPACITY OF LiFePO₄
ELECTRODES COATING A CARBON NONWOVEN
COLLECTOR, AND TESTED AT DIFFERENT RATES

| | Average | Average | Average |
|---|---|---|---|
| | specific | specific | specific |
| | capacity | capacity | capacity |
| | (mAh · g⁻¹) | (mAh · g⁻¹) | (mAh · g⁻¹) |
| | at D/20 | at D/10 | at D/5 |
| LiFePO₄-C1 | 149.1 | 147.2 | 142.5 |
| LiFePO₄-C2 | 148.8 | 146.9 | 142.2 |

LiFePO₄-C1 and LiFePO₄-C2 are two electrodes formed from the same ink.

Negative electrode cycling test results:

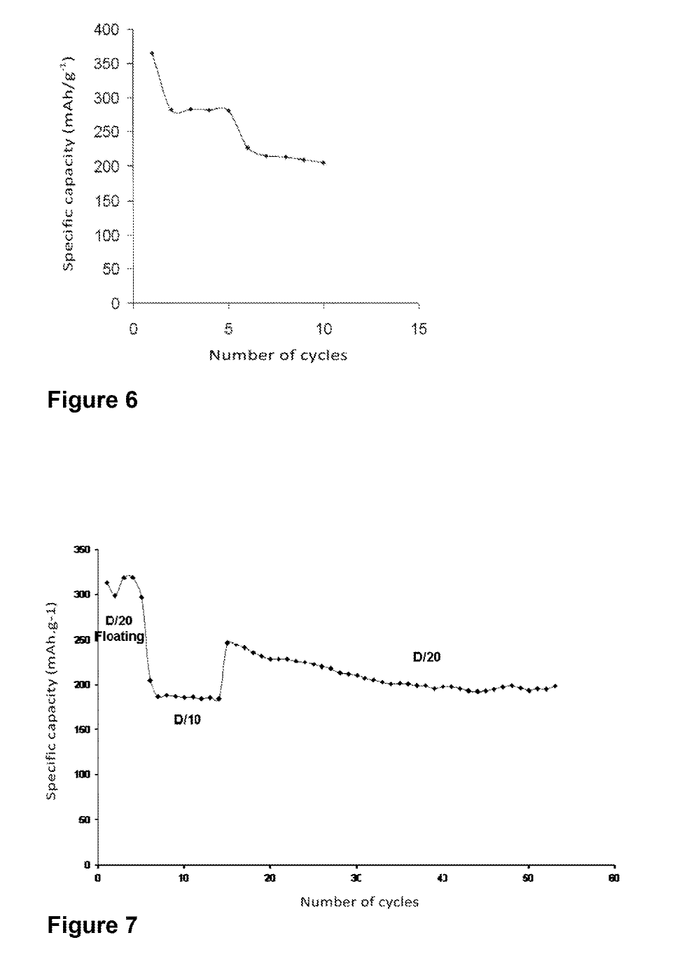

The specific capacity of the negative Cgr electrode is slightly greater than 308 mAh.g⁻¹ (average over the C/20 cycles, see FIG. 6). It is thus not necessary to compress the negative electrode to obtain the best results in terms of recovered specific capacity.

Thus, one of the non-foreseeable and very advantageous effects of the present invention relate to the insertion and the desinsertion of Li cations in the carbon nonwoven. The carbon fiber current conductor may thus be used as a negative electrode with no addition of additional active material. Its specific capacity has been assessed to 308 inAh.g⁻¹ (FIG. 7), due to a very slow half-cell cycling.

There clearly appears that the carbon nonwoven current collector may be used as a negative electrode. This electrode has the same specific capacity as a Cgr electrode. It however has the advantage of being much lighter. Further, when it is completed with an electrode containing PAAc as a polymer binder, the electrode compression step may be omitted, which enables to preserve the carbon nonwoven collector.

1. A method for manufacturing a lithium battery electrode comprising the steps of:
depositing an electrode ink on a current collector made of carbon fibers by coating or printing; said ink comprising at least one active electrode material, at least one polymer hinder, at least one electronic conductor;
drying: evaporating the solvent;
the current collector being porous and made of woven or nonwoven carbon fibers;
the polymer binder of the ink being poly(acrylic acid) having a molecular weight ranging between 1 000 000 and 2 500 000 g.mol⁻¹.

2. The method for forming an electrode for a lithium battery of claim 1, wherein the current collector has a porosity ranging between 70% and 85%, typically on the order of 80%.

3. The method for forming an electrode for a lithium battery of claim 1, wherein it further comprises a step of suction of the ink on the collector simultaneously to the deposition step or to the drying step or between these two steps, preferably on a drying table.

4. An electrode for a lithium battery obtained according to claim 1.

5. The electrode of claim 4, wherein said electrode is positive or negative.

6. The electrode of claim 4, wherein the area capacity of said electrode ranges between 0.1 and 10 mAh.cm⁻².

7. The electrode of claim 6, wherein the area capacity of said electrode ranges between 0.3 and 5 mAh.cm⁻².

8. A lithium accumulator comprising at least one electrode of claim 4.

9. A primary lithium battery comprising at least one electrode of claim 4.

10. A secondary lithium battery comprising at least one lithium accumulator of claim 8.
